(19) United States
(12) Patent Application Publication
(10) Pub. No.: US 2005/0180825 A1
(43) Pub. Date: Aug. 18, 2005

(54) Cutting insert having two opposite cutting heads

(75) Inventors: Johann Maier, Pflach (AT); Herbert Ronacher, Wangle (AT)

Correspondence Address: LERNER AND GREENBERG, PA, P O BOX 2480, HOLLYWOOD, FL, 33022-2480, US

(73) Assignee: Ceratizit Austria Gesellschaft m.b.H.

(21) Appl. No.: 11/018,441

(22) Filed: Dec. 21, 2004

Related U.S. Application Data
(63) Continuation of application No. PCT/AT03/00168, filed on Jun. 16, 2003.

(30) Foreign Application Priority Data
Jun. 21, 2002 (AT) GM 400/2002

(51) Int. Cl. B23B 27/14

(52) U.S. Cl. 407/113

(57) ABSTRACT

A cutting insert has two cutting heads that are opposite with respect to the longitudinal axis A of the insert. Each of the cutting heads has a cutting edge running substantially transversely to the longitudinal axis A and two side cutting edges or cutting-edge sections running substantially in the direction of the longitudinal axis A of the cutting insert. The side cutting edges run so as to fall away from the end cutting edge with respect to the tool reference plane Pᵣ. The flanks, lying on the same side of the cutting insert, of the side cutting edges of the opposite cutting heads in each case lie on a common plane E. This makes possible more cost-effective grinding of the side cutting edges.

### CROSS-REFERENCE TO RELATED APPLICATION:

This is a continuing application, under 35 U.S.C. § 120, of copending international application No. PCT/AT2003/000168, filed Jun. 16, 2003, which designated the United States; this application also claims the priority, under 35 U.S.C. § 119, of Austrian application No. GM 400/2002, filed Jun. 21, 2002; the prior applications are herewith incorporated by reference in their entirety.

### BACKGROUND OF THE INVENTION

1. Field of the Invention

The invention relates to a cutting insert having two opposite cutting heads with respect to its longitudinal axis A. Each of the cutting heads has an end cutting edge running essentially transversely to the longitudinal axis A and two side cutting edges or cutting-edge sections running essentially in the direction of the longitudinal axis A of the cutting insert. The associated flanks of the cutting edges enclose an angle α₁ of less than 90° with the tool reference plane Pᵣ through selected cutting points perpendicularly to the assumed cutting direction in accordance with DIN 6581.

Such cutting inserts are as a rule widely used for cutting-off in combination with longitudinal turning and/or facing operations. However, they are also suitable for milling when used in side milling cutters.

In order to be able to use such cutting inserts without any problems, the side cutting edges, during the machining operation, must enclose a certain angle with the workpiece surfaces to be machined in order not to come into simultaneous cutting engagement over the entire cutting length. This is achieved by a corresponding geometrical form of the cutting insert. In practice, this angle which the side cutting edges enclose with the workpiece surface is within the range of 0.5°-4°. In the known cutting inserts of this kind, the side cutting edges are normally arranged parallel to the workpiece reference plane Pᵣ of the cutting tool.

The workpiece reference plane Pᵣ, for the clear definition and description of the angles at the cutting part of a cutting tool, in the case of turning tools, is established in DIN 6581 (German Industrial Norm). According to DIN 6581, the reference plane Pᵣ is defined as a plane through a selected point of the cutting edge perpendicularly to the assumed cutting direction occurring in the position of use of the cutting edge.

Cutting inserts of the type are described, for example, in German utility model DE 295 03 246 U1 and in German published patent application DE 195 23 129 A1 (corresponding to U.S. Pat. No. 5,511,911). In order to achieve the clearance angle required for the machining, the flanks adjoining the end cutting edges and the side cutting edges in each case enclose an angle of less than 90° with the tool reference plane Pᵣ. In many cases, in particular in cutting inserts for the machining of aluminum and similar materials, these flanks have to be ground after the pressing and sintering of the cutting insert in order to obtain cutting edges which are as sharp as possible and/or close tolerances at the cutting insert and workpiece. Since the side cutting edges or cutting-edge sections, for a problem-free cutting insert, must enclose the requisite angle with a line parallel to the longitudinal axis A of the cutting insert, and at the same time the flanks adjoining the cutting edges in each case enclose an angle of less than 90° with the tool reference plane Pᵣ, the two side flanks of the opposite cutting heads which are arranged on the same side of the cutting insert do not lie on a common plane but on two different planes and therefore have to be ground separately from one another in two operations. This is relatively time-consuming and requires complicated grinding devices.

### SUMMARY OF THE INVENTION

It is accordingly an object of the invention to provide a cutting insert with two oppositely disposed cutting heads which overcomes the above-mentioned disadvantages of the heretofore-known devices and methods of this general type and which cutting insert can be ground more cost-effectively on simpler grinding devices.

With the foregoing and other objects in view there is provided, in accordance with the invention, a cutting insert, comprising:

a cutting insert body defining a longitudinal axis A and having two opposite cutting heads with respect to the longitudinal axis A;

the cutting heads each having an end cutting edge running substantially transversely to the longitudinal axis A, and two side cutting edges (or cutting-edge sections) running substantially in a direction of the longitudinal axis A;

the end cutting edge and the side cutting edges having associated flanks enclosing an angle α₁ of less than 90° with a tool reference plane Pᵣ through selected cutting points perpendicularly to an assumed cutting direction in accordance with DIN 6581;

the side cutting edges falling away from the end cutting edge with respect to the tool reference plane Pᵣ; and

the flanks of the side cutting edges of the two opposite cutting heads arranged on a same side of the cutting insert body in each case lying on a common plane E.

In other words, the invention achieves the above objects in that the side cutting edges run so as to fall away from the end cutting edge with respect to the tool reference plane Pᵣ, and in that the flanks of the side cutting edges of the two opposite cutting heads which are arranged on the same side of the cutting insert in each case lie on a common plane E.

Owing to the fact that the side cutting edges run so as to fall away from the end cutting edge with respect to the tool reference plane Pᵣ, in connection with the clearance angle of their flanks, an angle of these side cutting edges relative to the wall of the workpiece parallel to the longitudinal axis A of the cutting insert is achieved during the machining even when the associated flanks of the opposite cutting heads which are arranged on the same side of the cutting insert in each case line on a common plane E. A correspondingly designed cutting insert ensures that, during a requisite grinding operation, the two flanks, lying on the same side of the cutting insert, of the side cutting edges of the opposite cutting heads can be ground simultaneously in a single operation without changing the position of the cutting insert. In this way, the grinding operation and the machining device required for carrying out the grinding operation are substantially simplified and thus become more cost-effective.

The side cutting edges may be configured to fall away from the end cutting edge in a straight or curved manner, where, in the case of straight, side cutting edges, the cutting edges enclose an angle α₂ within the range of 5°-25° with the tool reference plane Pᵣ and, in the case of curved, side cutting edges, the tangents in the center region of the cutting edges enclose an angle α₂ within the range of 5°-25° with the tool reference plane Pᵣ.

However, the invention can be realized not only in the case of cutting inserts having straight cutting edges in plan view but also in the case of those having circular end cutting edges and side cutting-edge sections which run approximately parallel to the longitudinal axis A of the cutting insert and results in a marked simplification in the grinding operation. In cutting inserts having circular, end cutting edges, the side cutting-edge sections which run approximately parallel to the longitudinal axis A are designed to fall away from the end cutting edges, and their associated flanks, at the opposite cutting heads, on the same side of the cutting insert in each case lie on a common plane E of the cutting insert.

The cutting inserts are designed in an especially advantageous manner for the machining of aluminum when the angle α₁ is within the range of 75°-83° and when the side cutting edges or the tangents in the center region of the side cutting edges enclose an angle α₂ within the range of 15°-25° with the tool reference plane Pᵣ.

Other features which are considered as characteristic for the invention are set forth in the appended claims.

Although the invention is illustrated and described herein as embodied in a cutting insert having two opposite cutting heads, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a side view of a cutting insert according to the invention;

FIG. 2 is an end view of the cutting insert of FIG. 1;

FIG. 3 is a section taken along the line III-III through the cutting insert according to FIG. 1;

FIG. 4 is a plan view of the cutting insert of FIG. 1;

FIG. 5 is a view of the cutting insert of FIG. 1, viewed in a direction indicated by the arrow;

FIG. 6 is a side view of a variant of a cutting insert according to the invention;

FIG. 7 is an end view of the cutting insert of FIG. 6;

FIG. 8 is a section taken along the line XIII-XIII through the cutting insert of FIG. 6;

FIG. 9 is a plan view of the cutting insert of FIG. 6; and

FIG. 10 is a view of the cutting insert of FIG. 6 viewed in the direction of the arrow.

### DESCRIPTION OF THE PREFERRED EMBODIMENTS

Referring now to the figures of the drawing in detail and first, particularly, to FIGS. 1 to 5 thereof, there is shown a cutting insert 1 according to the invention. The insert 1 has two opposite cutting heads with in each case a straight, end cutting edge 3 and two straight, side cutting edges 4. The two opposite cutting heads 2, 2′ with respect to the longitudinal axis A of the cutting insert 1 are designed to be exactly symmetrical. The respective end cutting edges 3 run perpendicularly to the longitudinal axis A. The tool reference plane Pᵣ of the cutting insert 1 is established in accordance with DIN 6581 as a plane perpendicular to the assumed cutting direction 6 of the end cutting edge 3. Adjoining the end cutting edge 3 is the flank 7, and adjoining the side cutting edges 4 are the flanks 5, which enclose a respective angle α₁ of 83° with the tool reference plane Pᵣ. The side cutting edges 4 are designed to fall away in a straight manner from the end cutting edge 3 with respect to the tool reference plane Pᵣ and enclose a respective angle α₂ of 25° with the tool reference plane Pᵣ.

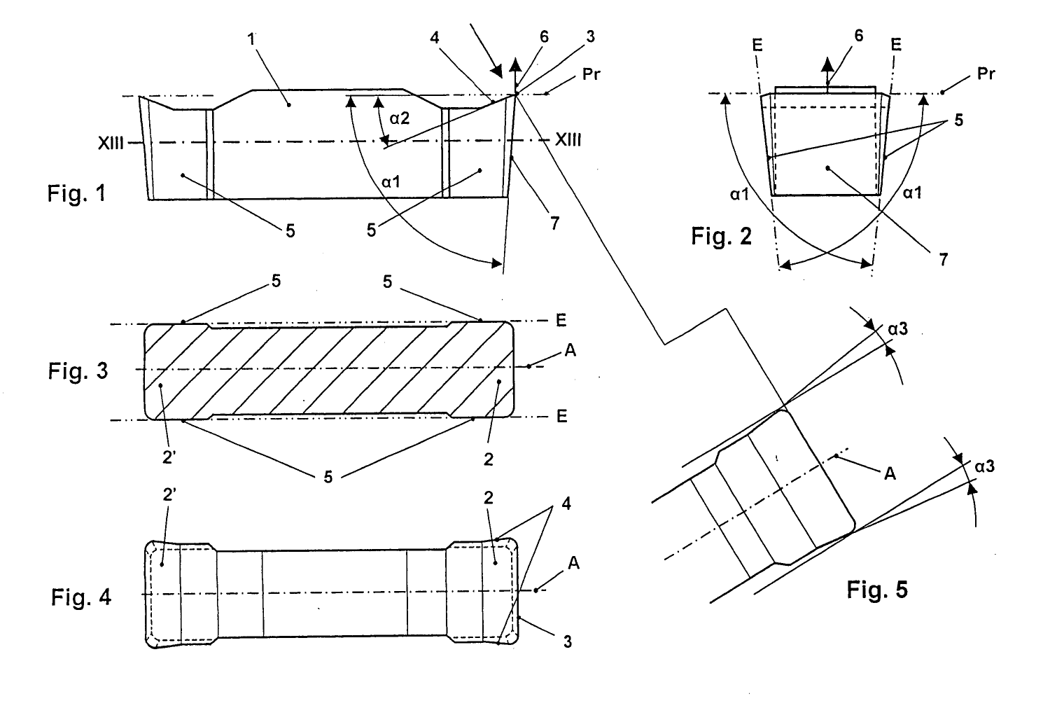

As can be seen from FIGS. 2 and 3, the flanks 5 of the opposite cutting heads 2, 2′ which in each case lie on the same side of the cutting insert 1 lie on a common plane E. It is therefore possible, for producing ground, side cutting edges 4, to grind both flanks 5 on one side of the cutting insert 1 in each case continuously in one operation without changing the position of the cutting insert 1. It is thus possible to use simpler grinding devices and to reduce the production costs of the cutting insert. Although these flanks 5 lie on a common plane E, the fact that the profile of the side cutting edge 4 falls away with respect to the end cutting edge 3 means that, in connection with the inclination of the flanks 5 with respect to the tool reference plane Pᵣ, the side cutting edges 4, during the machining, e.g. during a cutting-off operation, enclose along their profile an angle α₃ with the side wall of the machined workpiece surface and thus run free. This is illustrated in FIG. 5.

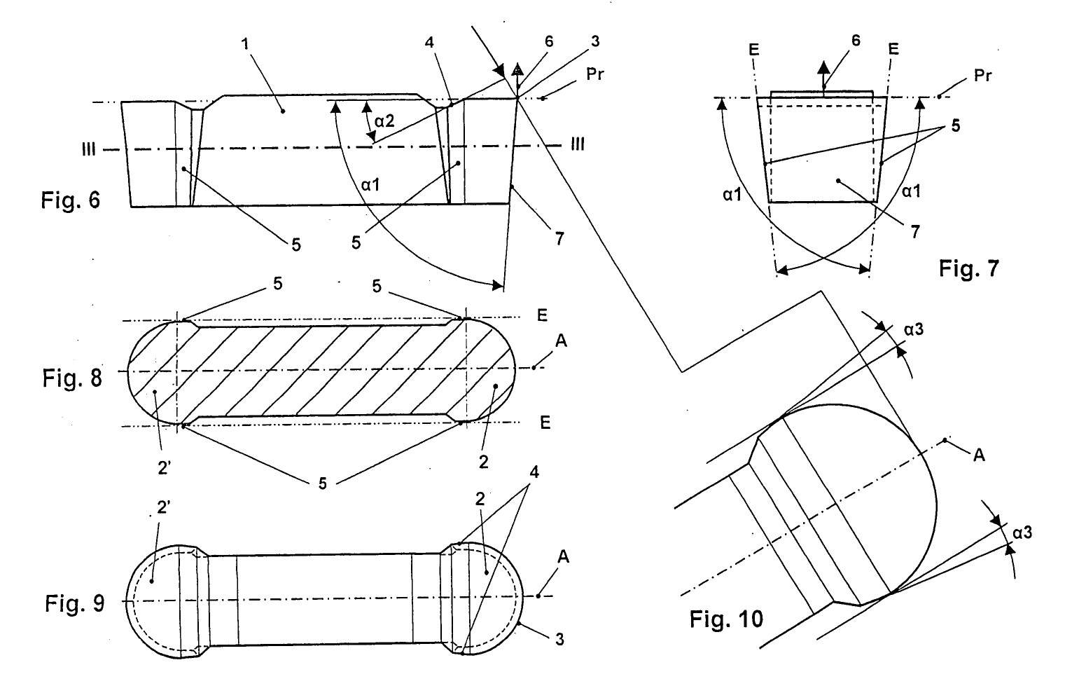

FIGS. 6 to 10 show the corresponding ratios in a variant embodiment of a cutting insert 1 according to the invention having substantially circular end cutting edges 3. The cutting-edge sections of the cutting heads 2, 2′ which run approximately parallel to the longitudinal axis A of the cutting insert are designed as straight, side cutting-edge sections 4 which again run so as to fall away from the end cutting edges 3 and enclose an angle α₂ with the tool reference plane Pᵣ. Their associated flanks 5 of the opposite cutting heads 2, 2′ are arranged on the same side of the cutting insert on a common plane E, so that a simplified and thus more cost-effective grinding operation is made possible.

1. A cutting insert, comprising:
a cutting insert body defining a longitudinal axis A and having two opposite cutting heads with respect to the longitudinal axis A;
said cutting heads each having an end cutting edge running substantially transversely to the longitudinal axis A, and two side cutting edges (or cutting-edge sections) running substantially in a direction of the longitudinal axis A;
said end cutting edge and said side cutting edges having associated flanks enclosing an angle α₁ of less than 90° with a tool reference plane Pᵣ through selected cutting points perpendicularly to an assumed cutting direction in accordance with DIN 6581;
said side cutting edges falling away from said end cutting edge with respect to the tool reference plane Pᵣ; and
said flanks of said side cutting edges of said two opposite cutting heads arranged on a same side of said cutting insert body in each case lying on a common plane E.

2. The cutting insert according to claim 1, wherein said cutting heads each are formed of a straight, end cutting edge running transversely to said longitudinal axis A, and of straight, side cutting edges, and said side cutting edges enclose an angle α₂ within the range of 5°-25° with the tool reference plane Pᵣ.

3. The cutting insert according to claim 1, wherein said cutting heads each are formed of a straight, end cutting edge running transversely to said longitudinal axis A, and of curved side cutting edges, said curved side cutting edges having a center region defining tangents enclosing an angle α₂ within a range of 5°-25° with the tool reference plane Pᵣ.

4. The cutting insert according to claim 1, wherein said end cutting edge is a circular cutting edge, with two straight side cutting-edge sections enclosing an angle α₂ within the range of 5°-25° with the tool reference plane Pᵣ.

5. The cutting insert according to claim 1, wherein said angle α₁ is within a range of 75°-83° and said angle α₂ is within a range of 15°-25°.

6. The cutting insert according to claim 1, configured for machining aluminum, and having an angle α₁ between 75° and 83° and an angle α₂ between 15° and 25°.
